(19) United States
(12) Patent Application Publication
(10) Pub. No.: US 2017/0224456 A1
(43) Pub. Date: Aug. 10, 2017

(54) Device for Fixing a Temperature Sensor Intended to be Placed in the Auditory Canal of an Animal

(71) Applicant: Allflex Europe, Vitré (FR)

(72) Inventors: Jean-Jacques Hilpert, Vitre (FR); Johan Decaluwe, Laval (FR); Johan de Meulemeester, De Pinte (BE)

(73) Assignee: Allflex Europe, Vitré (FR)

(21) Appl. No.: 15/500,825

(22) PCT Filed: Jul. 2, 2015
(86) PCT No.: PCT/EP2015/065153

§ 371 Date: Jan. 31, 2017

(30) Foreign Application Priority Data
Jul. 31, 2014 (FR) 1457455

(51) Int. Cl. A61D 13/00

(52) U.S. Cl. CPC A61D 13/00

(57) ABSTRACT

The invention relates to a device for fixing at least one temperature sensor to an animal, intended to be placed in the auditory canal of an animal. According to the invention, such a device comprises a first portion (31, 41, 51, 61, 71) defining at least one seat (311, 411, 511, 611, 711) for receiving at least one temperature sensor and means for transmitting at least one temperature value, and a second portion (32, 42, 52, 62, 72) forming a spring, the first portion and/or the second portion being configured to bear on at least two separate zones of the auditory canal of the animal, said second portion (42, 52) comprising at least one leaf spring, and said first portion (41, 51) being a helical element connected to said at least one leaf spring.

### 1. FIELD OF THE INVENTION

The field of the invention is that of the collection of information about animals.

More specifically, the invention relates to a device and a system for affixing a temperature sensor that is to be placed in an animal's auditory canal, enabling an animal's temperature to be taken at particular times or throughout its existence.

In particular, such a system can be equipped with visual and/or electronic identification means used to identify the animal that carries it.

Such a system is meant to be affixed to any type of animal, whether a pet or a farm animal, and especially animals for consumption.

### 2. PRIOR ART

In order to improve the tracking of livestock, improve productivity, detect illnesses, detect ovulation periods, and calving from the very first symptoms, and/or track the progress of an illness, it is becoming increasingly common to take different temperature readings of the animals concerned.

To this end, the patent application US2011251514 (Fever Tags®) has proposed the association of a temperature probe with a tag that is to be affixed to an animal's ear.

Such a temperature-reading system, illustrated in FIG. 1, comprises a male part 11 and a female part 12, forming the tag, and a probe 13 used to carry out temperature readings. The probe 13 is connected to the female part 12 by means of a cable 14. The female part 12 is furthermore equipped with a visual indicator 121 used to warn a breeder in the event of abnormal temperature in the animal.

The probe 13, as well as a part of the cable 14, are inserted into the animal's auditory canal. The rest of the system is external to the auditory canal and is affixed conventionally to the animal's ear, by the insertion of the male part 11 into the female part 12 through the animal's ear.

One drawback of this prior art system is that it is particularly bulky. There is a risk that the animal will get the cable 14 trapped in a branch or a fence, leading to the removal of the probe 13, or that it will rub against another animal and damage the system. In addition, such a system can be inconvenient for the animal.

Another drawback of this prior-art system is that it does not replace the animal identification marks which must obligatorily be placed on at least one ear of the animal according to legislation in many countries so as to enable the traceability and the certification of the origin of the animals. It is therefore necessary to pierce the animal's ear twice, once to place the identification mark and once to affix the temperature-reading system. This causes additional suffering for the animal and may be prohibited in certain countries.

There is therefore a need for a novel system for reading temperature in an animal that does not have all these drawbacks of the prior art.

### 3. SUMMARY OF THE INVENTION

The invention proposes a novel solution in the form of a device for affixing at least one temperature sensor to an animal, to be placed in an animal's auditory canal.

According to the invention, such a device comprises:

a first portion defining at least one housing capable of receiving at least one temperature sensor and means for transmitting at least one temperature value, and

a second portion forming a spring,

the first portion and/or the second portion being configured to take support on at least two distinct zones of the auditory canal.

Thus, the invention relies on a novel and inventive approach to the reading of temperature in an animal through the full placing of the device in the animal's auditory canal, giving, for example, greater compactness, less discomfort to the animal and a reduction of the risk of malfunctioning due to the external environment (for example from another animal in the herd or through getting trapped in vegetation or a fence, etc.)

It can be noted that such a device can be held in the auditory canal through the second portion forming a spring (or spring-forming portion). The second portion can be supported on at least two distinct areas of the auditory canal, in order to keep the device in position. As a variant, the first portion and the second portion each take support on a distinct zone of the auditory canal. In this way, the housing defined in the first portion is in contact with the auditory canal, thus enabling the temperature to be taken more efficiently.

In particular, the two distinct zones of the auditory canal are diametrically opposite, thus providing for better positioning and holding of the device in the auditory canal.

In addition, the second spring-forming portion leaves an air passage in the auditory canal. The device according to the invention therefore does not impair the auditory capacities of the animal.

According to one particular characteristic of the invention, the second portion is configured to take at least two positions, a compressed position and a holding position. In the compressed position, the second portion is deformed so as to enable the insertion of the device into the auditory canal. In the holding position, the second portion substantially resumes and/or tends to return to its original shape so as to hold the device fixedly in the auditory canal.

In particular, the housing capable of receiving at least one temperature sensor and transmission means for transmitting at least one temperature value comprise an entry hole for the temperature sensor and at least one air vent hole.

Such an air vent hole facilitates the insertion of the temperature sensor into the housing.

According to one particular characteristic of the invention, the first portion defines a substantially cylindrical housing, a height of which coincides with a first support zone of the auditory canal when the device is placed in this auditory canal.

The invention thus defines a zone of close contact maximized between the temperature sensor and the wall of the animal's auditory canal, thus enabling a temperature to be taken efficiently.

In particular, the entry hole for the temperature sensor is situated on a first base of the substantially cylindrical housing, and the air vent hole or holes are situated in proximity to a second base of the substantially cylindrical housing.

According to a first embodiment, the second spring-forming portion takes the form of a sheath at least partially enveloping the first portion.

In particular, the sheath and the first portion coincide on a part designed to take support on the first zone of the auditory canal. In addition, the sheath is flexible at the level of a part that is to take support on the second zone of the auditory canal. This especially facilitates the positioning of the device in the animal's auditory canal.

According to one particular characteristic, the sheath comprises at least one air inlet hole and an air outlet hole situated on either side of the part that is to take support on the second zone of the auditory canal. Such holes enable a passage of air in the auditory canal so as not to impair the animal's auditory capacities.

According to another particular characteristic, the sheath has a bullet or ogival shape. Its first extremity, in the sense in which the device is inserted into the auditory canal, therefore has a rounded shape, facilitating the insertion of the device into the animal's auditory canal and avoiding any injury to the animal.

In particular, the sheath has a longitudinal axis substantially parallel to a longitudinal axis of the housing.

According to another embodiment of the invention, the second portion comprises at least one spring leaf and the first portion is a helicoidal element connected to the spring leaf or leaves.

For example, according to a second embodiment, the second portion comprises a single spring leaf. In this case, the helicoidal element forming the first portion can take support on a first zone of the auditory canal, and the spring leaf forming the second portion can take support on a second zone of the auditory canal.

According to a third embodiment, the second portion comprises three spring leaves, distributed at equal distances around the helicoidal element. In this case, each spring leaf can take support on a distinct zone of the auditory canal, in distributing the different forces equally.

According to a fourth embodiment of the invention, the second spring-forming portion is a flexible plate connected by one of its sides to the first portion.

According to this embodiment, in the compressed position, the flexible plate can be wound at least partially about the first portion so as to facilitate the insertion of the device into the auditory canal.

According to a fifth embodiment of the invention, the first and second portions comprise a helicoidal element formed by at least one coil having a first diameter, defining the housing, and at least one coil having a second diameter, forming a spring, the second diameter being greater than the first diameter.

According to another aspect of the invention, the device also comprises at least one housing capable of receiving electronic means to identify an animal.

In particular, the electronic identification means, the temperature sensor and the means for transmitting at least one temperature value can be placed in the same housing in order to reduce the space requirement of the device.

In this case, the means for transmitting at least one temperature value can also be used to transmit an identifier of the animal.

According to another particular characteristic of the invention, the device comprises a marking surface for an identifier of the animal. For example, such a marking surface is defined on the flexible plate, on the sheath or on the spring leaf of the affixing device.

This makes it possible to have a visually identification for the animal, so that its identity can be verified when the device is removed for example.

According to one particular characteristic, the device comprises means for removing the device.

Such means take, for example, the form of a thread hooked to the first and/or to the second portion, a notch, etc. accessible by hand or by means of a specific tool in order to retrieve the device with total ease when necessary.

The invention also relates to a system for affixing at least one temperature sensor, to be placed in an animal's auditory canal, to this animal.

According to the invention, such a system comprises:

a device for affixing as described above;

at least one temperature sensor and means for transmitting at least one temperature value, inserted into a housing of the affixing device.

In particular, a system comprises a device for affixing as described above. It could therefore naturally comprise the different characteristics of the affixing device according to the invention, which can be combined or taken in isolation. Thus, the characteristics and advantages of this system are the same as those of the affixing device. They are therefore not described in more ample detail.

In particular, the system also comprises electronic means for identifying the animal, inserted into the housing or into another housing of the affixing device.

According to one particular embodiment, the electronic identification means, the temperature sensor and the means for transmitting at least one temperature value are preliminarily inserted into a glass capsule or glass tag inserted into the housing formed by the first portion of the affixing device.

Such a system can be used especially to place a temperature sensor entirely in an animal's auditory canal for greater compactness, avoid discomfort to the animal and/or reduce the risk of malfunctioning due to the external environment.

This system also enables a temperature sensor and electronic identification means to be totally placed into the animal's auditory canal, thus preventing the animal's ear from being pierced several times as proposed in the prior art.

### 4. LIST OF FIGURES

Other features and advantages of the invention shall appear more clearly from the following description of particular embodiments, given by way of simple, illustratory and non-exhaustive examples, and from the appended drawings of which:

FIG. 1 presents a system of temperature readings known in the prior art;

FIG. 2 is a view in perspective or three-quarter view of a glass capsule as inserted into an affixing device according to one embodiment of the invention;

FIGS. 3A and 3B illustrate different views of a first embodiment of the invention;

FIGS. 4A and 4B illustrate different views of a second embodiment of the invention;

FIGS. 5A and 5B illustrate different views of a third embodiment of the invention;

FIGS. 6A and 6B illustrate different views of a fourth embodiment of the invention;

FIGS. 7A and 7B illustrate different views of a fifth embodiment of the invention.

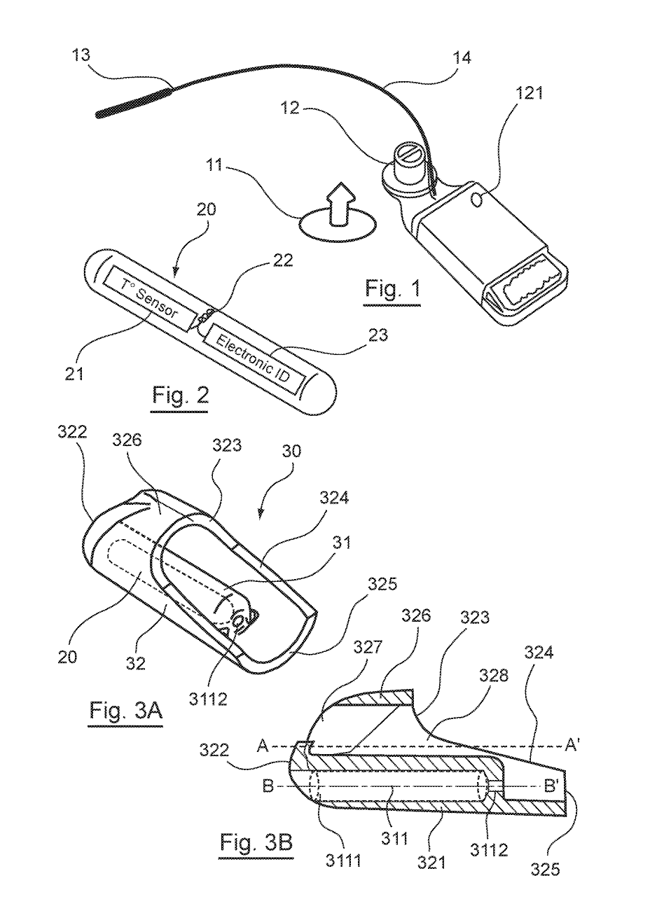

### 5. DESCRIPTION OF EMBODIMENTS OF THE INVENTION

### 5.1 General Principle

The general principle of the invention relies on a device for affixing at least one temperature sensor comprising two portions, of which a first portion defines at least one housing to receive the temperature sensor or sensors and means for transmitting temperature readings, this first portion taking support, if necessary, on at least one zone of the auditory canal, and of which a second spring-forming portion is to take support on at least one zone of the auditory canal.

Therefore, such a device, or rather the affixing system comprising such a device, at least one temperature sensor and means for transmitting temperature readings, can be totally inserted into an animal's auditory canal. Such a system can be placed permanently in the auditory canal in order to take one or more temperature readings and transmit these readings to a reader, place outside the animal.

To this end, the first portion of the affixing device defines a housing capable of receiving the temperature sensor or sensors, means for transmitting the temperature readings and, as the case may be, electronic means for identifying animals.

For example, as illustrated in FIG. 2, the temperature sensor or sensors 21, the means 22 for transmitting the temperature readings, and, as the case may be, the electronic means 23 for identifying the animal, are pre-inserted into a glass capsule 20, also called a glass tag. The first portion then defines a substantially cylindrical housing capable of receiving such a glass tag.

In particular, if the glass tag comprises electronic means 23 for identifying the animal, comprising for example an antenna connected to a storage element carrying an identifier of the animal, the antenna of the electronic identification means can coincide with or be pooled with the antenna forming the means 22 for transmitting temperature readings. In this case, the first portion can define a single housing used to receive the glass tag 20 comprising the temperature sensor or sensors 21, the means 22 for transmitting the temperature readings, and the electronic means 23 for identifying the animal.

According to another embodiment, at least one second housing is provided to receive the electronic identification means. In this case, an antenna of the electronic identification means is not necessarily common with the antenna forming the means 22 for transmitting temperature readings.

The second portion of the affixing device, for its part, forms a spring. It is therefore capable of taking at least two positions, including:

a compressed position in which this second portion is deformed so as to enable the insertion of the device into the animal's auditory canal;

a holding position, in which the second portion tends to resume its original shape so as to maintain the device in the auditory canal.

Referring now to FIGS. 3A to 7B, we now present different embodiments of a device or a system for affixing a temperature sensor according to the invention, designed to be placed in an animal's auditory canal.

### 5.2 First Embodiment

to a first embodiment, illustrated in FIGS. 3A and 3B, we consider an affixing system 30 comprising a glass tag 20 as illustrated in FIG. 2 (or more generally a temperature sensor and means for transmitting at least one temperature value), and a device for affixing a temperature sensor. Such an affixing device comprises a first portion 31 designed to take support on a first zone of the auditory canal, defining at least one housing capable of receiving the glass tag and a second spring-forming portion 32 designed to take support on a second zone of the auditory canal, the first and second zones of the auditory canal being substantially diametrically opposite.

According to this first embodiment, the first portion 31 defines a substantially cylindrical housing 311, a height of which coincides with the first zone of the auditory canal, when the system 30 is placed inside it. An entry hole 3111 for the temperature sensor, situated on a first base of the cylindrical housing 311, enables the insertion of the glass tag 20 into this housing 311. In order to facilitate the insertion of the glass tag 20 into the housing 311, the invention also provides for an air vent hole 3112 in proximity to a second base of the cylindrical housing 311.

The second spring-forming portion 32 takes the form of a bullet-shaped or ogival sheath, at least partially enveloping the first portion 31.

For example, such a sheath has a longitudinal axis AA′ substantially parallel to a longitudinal axis BB′ of the housing 311. In particular, the sheath and the first portion coincide on a part 321 that is to take support on the first zone of the auditory canal, at the height of the housing 311.

The first end 322 of the sheath, in the sense of the introduction of the system into the auditory canal, has a rounded shape, so as to facilitate the insertion of the system 30 into the animal's auditory canal.

The other end of the sheath has a recess which makes it possible especially to limit the quantity of material used to manufacture the affixing device, the recess comprising:

a curved section 323;

an inclined section 324;

a section 325 substantially perpendicular to the longitudinal axis AA′ of the sheath.

In order to form a spring, the sheath has a flexible part 326 that takes support on the second zone of the auditory canal. Such a flexible part 326 can be compressed when the system 30 is inserted into the animal's auditory canal, and then relaxed so that it attempts to resume its original shape in order to maintain the system 30 in the animal's auditory canal.

To this end, the sheath is made for example out of a flexible plastic material such as polyurethane. The first portion 31 can also be made of polyurethane in order to facilitate the force-fitting of the glass tag 20 into the housing 311.

In addition, the sheath has at least one air inlet hole 327 and at least one air outlet hole 328 situated on either side of the flexible part 326 that is to take support on the second zone of the auditory canal, so as not to impair the auditory capacities of the animal when the system is placed in the animal's auditory canal.

### 5.3 Second Embodiment

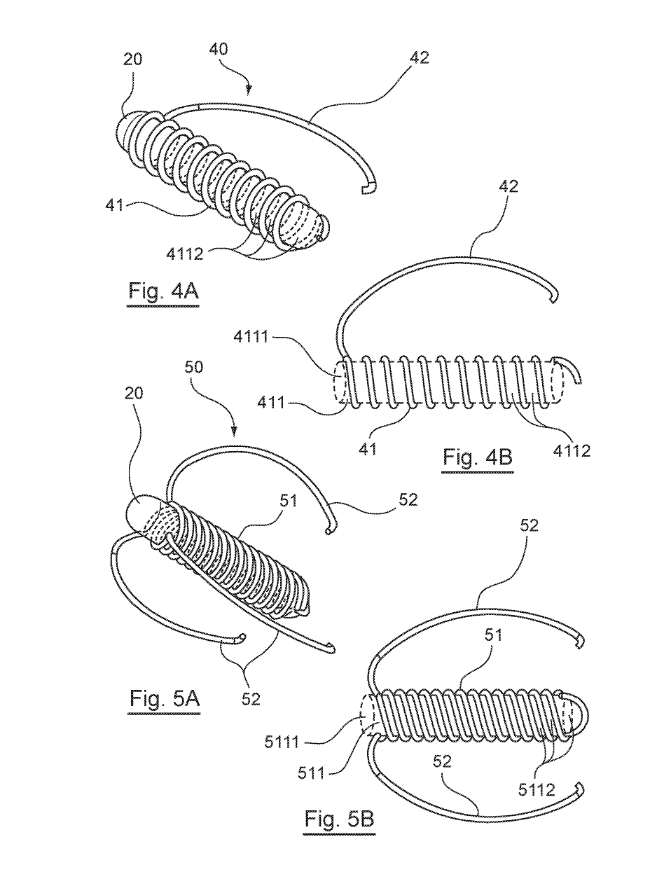

Referring now to FIGS. 4A and 4B, we present a second embodiment of the invention.

The description again considers an affixing system 40 comprising a glass tag 20 as illustrated in FIG. 2 (or more generally a temperature sensor and means for transmitting at least one temperature value), and a device for affixing a temperature sensor.

Such an affixing device has a first portion 41 that is to take support on a first zone of the auditory canal, defining at least one housing capable of receiving the glass tag 20 and a second spring-forming portion 42 that is to take support on a second zone of the auditory canal, the first and second zones of the auditory canal being substantially diametrically opposite.

According to this second embodiment, the first portion 41 is a helicoidal element. This helicoidal element defines a substantially cylindrical housing 411, a height of which coincides with the first zone of the auditory canal when the system 40 is placed inside it. An entry hole 4111 for the temperature sensor, situated on a first base of the substantially cylindrical housing 411, enables the insertion of the glass tag 20 into the housing 411. In order to facilitate the insertion of the glass tag 20 into the housing 411, a plurality of air vent holes 4112 are also provided in proximity to a second base of the substantially cylindrical housing 411, enabling air venting during the insertion of the glass tag into the housing 411.

The second spring-forming portion 42 takes the form of a spring leaf connected to the helicoidal element. This spring leaf enable easy insertion of the system 40 into the auditory canal when it is situated in its compressed position and enables the system 40 to be held in the auditory canal when it tends to resume its original shape.

For example, the spring leaf and the helicoidal element can be formed as a single piece, using a metal or plastic rod that is wound to form the first portion 41 and curved to form the second portion 42.

### 5.4 Third Embodiment

Referring now to FIGS. 5A and 5B, we present a third embodiment of the invention.

An affixing system 50 is considered again. This system 50 comprises a glass tag 20 as illustrated in FIG. 2 (or more generally a temperature sensor and means for transmitting at least one temperature value), and a device for affixing a temperature sensor.

Such an affixing device comprises a first portion 51 defining a housing capable of receiving the glass tag 20 and a second portion 52 that is to take support on at least two zones of the auditory canal, for example three zones, situated substantially at equal distances in the auditory canal.

According to this third embodiment, the first portion 51 is a helicoidal element defining a substantially cylindrical housing 511.

An entry hole 5111 for the temperature sensor, situated on a first base of the substantially cylindrical housing 511, enables the insertion of the glass tag 20 into this housing 511. In order to facilitate the insertion of the glass tag 20 into the housing 511, a plurality of air vent holes 5112 are also provided in proximity to a second base of the substantially cylindrical housing 511, enabling air to be vented during the insertion of the glass tag 20 into the housing 511.

The second spring-forming portion 52 takes the form of a plurality of spring leaves, for example three spring leaves, connected to the helicoidal element. These spring leaves enable easy insertion of the system 50 into the auditory canal when they are situated in their compressed position, and enable the system 50 to be maintained in the auditory canal when they tend to resume their original shape.

For example, the helicoidal element is formed by three helixes. A spring leaf and a helix can then be formed as one piece, using a metal or plastic rod that is wound to form the helix and curved to form the spring leaf. The three “spring leaf/helix” assemblies are then joined together to close the housing 511.

### 5.5 Fourth Embodiment

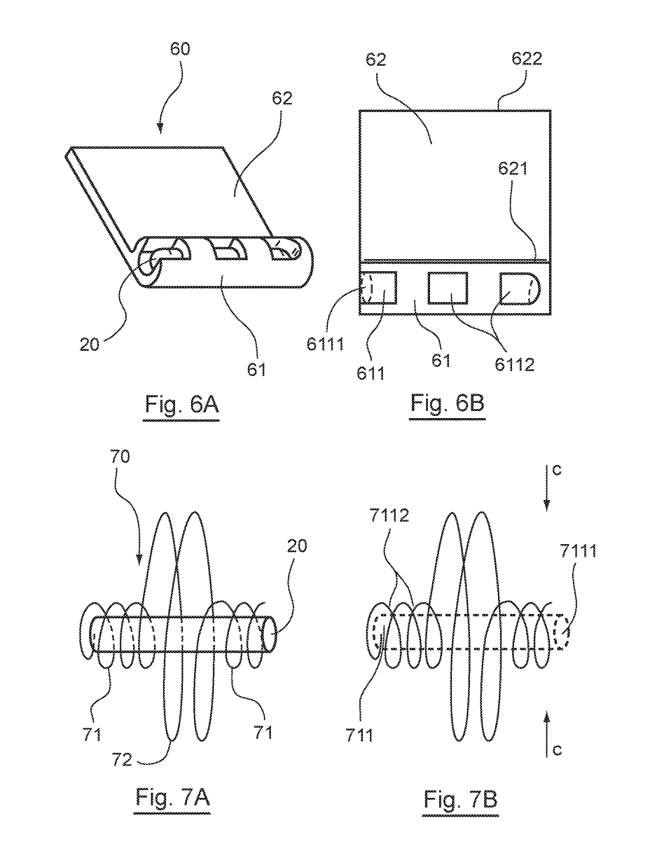

Referring now to FIGS. 6A and 6B, we present a fourth embodiment of the invention.

An affixing system 60 is considered again. This system 60 comprises a glass tag 20 as illustrated in FIG. 2 (or more generally a temperature sensor and means for transmitting at least one temperature value), and a device for affixing a temperature sensor.

Such an affixing device comprises a first portion 61 that is to take support on a first zone of the auditory canal defining a housing capable of receiving the glass tag 20 and a second portion 62 that is to take support on at least one second zone of the auditory canal.

According to this fourth embodiment, the first portion 61 defines a substantially cylindrical housing 611, a height of which coincides with the first zone of the auditory canal when the system 60 is placed inside it. An entry hole 6111 for the temperature sensor, situated on a first base of the substantially cylindrical housing 611, enables the insertion of the glass tag 20 into the housing 611. In order to facilitate the insertion of the glass tag 20 into this housing 611, at least one air vent hole 6112 is provided in proximity to a second base of the cylindrical housing 611, enabling air to be vented during the insertion of the glass tag 20 into the housing 611.

The second spring-forming portion 62 comprises a flexible plate, for example substantially rectangular, connected by one of its sides 621 to the first portion 61.

For example, such a plate is made of flexible plastic with memory effect, or it is a metal leaf over-molded with polyurethane. The first portion 61 can also be made of polyurethane in order to facilitate the force-fitting of the glass tag 20 into the housing 611.

In its compressed position, the flexible plate is at least partially wound around the first portion 61, facilitating the insertion of the system 60 into the auditory canal. In the holding position, the flexible plate is at least partially unwound. Thus, the affixing device can take support on a first zone of the auditory canal at the first portion 61 and on a second zone of the auditory canal at the side 622 opposite the side 621 connected to the first portion 61.

### 5.6 Fifth Embodiment

Referring now to FIGS. 7A and 7B, we present a fifth embodiment of the invention.

An affixing system 70 is considered again. This system 70 comprises a glass tag 20 as illustrated in FIG. 2 (or more generally a temperature sensor and means for transmitting at least one temperature value), and a device for affixing a temperature sensor. Such an affixing device comprises a first portion 71 defining at least one housing capable of receiving the glass tag 20 and a second spring-forming portion 72 that is to take support on at least two substantially diametrically opposite zones of the auditory canal.

According to this fifth embodiment, the first portion 71 and the second portion 72 comprise a helicodal element formed by at least one coil having a first diameter, defining a substantially cylindrical housing 711 and at least one spring-forming coil having a second diameter greater than the first diameter.

An entry hole 7111 for the temperature sensor, situated on a first base of the substantially cylindrical housing 711, enables the insertion of the glass tag 20 into this housing 711. In order to facilitate the insertion of the glass tag 20 into the housing 711, a plurality of air vent holes 7112 are also provided in proximity to a second base of the substantially cylindrical housing 711.

The first portion 71 is formed by at least one coil having a first diameter, connected to the second portion 72 formed by at least one coil having a second diameter, greater than the first diameter.

The coils of the second spring-forming portion 72 can be compressed in the sense illustrated by the arrows C, in the compressed position, enabling easy insertion of the system 70 into the auditory canal. These coils of the second portion 72 enable the system 70 to be held in the auditory canal when they tend to resume their original shape.

For example, the helicoidal element formed by coils having a first diameter and a second diameter can be formed as one piece, using a metal or plastic rod that is wound along the first diameter to form the first portion 71 and wound along the second diameter to form the second portion 72.

### 5.7 Alternative Embodiments

In the embodiments present above, it has been assumed that the temperature sensor or sensors, the means for transmitting at least one temperature reading, and as the case may be the electronic identification means, are inserted into a glass tag. Naturally, this is only one example of implementation, and the temperature sensor or sensors, the means for transmitting at least one temperature reading, and as the case may be the electronic identification means can take any other form. It must be noted that the shape of the housing of the first portion of the affixing device can be adapted to receive at least the temperature sensor or sensors and the means for transmitting at least one temperature reading.

In addition, the affixing device can have a marking surface, for example on the flexible plate, on the sheath, on the spring leaf, on the helicoidal elements etc. Thus, a visual means for identifying the animal can also be added to the affixing device instead of, or in addition to, the electronic identification means. Such visual and/or electronic identification means carry an identifier of the animal (identification number for example). This marking can be done by any known means (printing, laser etching, inkjet printing, etc.)

For setting up the affixing system, a clamp-type tool can be used enabling the compression of the second portion to bring it into its compressed position. The affixing device of the affixing system can also be placed in compressed position into an injector such as a syringe and released into the auditory canal. The second portion then seeks to resume its original shape, thus enabling the system to be permanently affixing into the auditory canal The affixing system can also be force-fitted into the auditory canal.

To this end, it can be noted that the total height of the affixing systems 30, 40, 50, 60 and 70, before they are placed in the auditory canal, is at least equal to the diameter of the auditory canal of the animal concerned in order to ensure that the system is properly held in the auditory canal and to prevent involuntary extraction. The dimensions of the affixing device are suited to the dimensions of the auditory canal of the concerned animal and therefore vary from one category of animal to another. For example, the diameter of the auditory canal of bovines is considered to be about 8 mm. The diameter of the affixing device in its initial state can be of the order of 9 mm. Thus, in the compressed position, the second spring-forming portion should be compressed to reduce the diameter/height of the affixing device to a dimension of less than 8 mm and, in the holding position, the second portion tends to resume its original shape and is therefore blocked by the walls of the auditory canal.

Besides, in order to facilitate the removal of the system from the animal's auditory canal, the affixing device can be equipped with a means of removal such as for example a thread, a notch capable of co-operating with a specific tool, etc.

1. Device for affixing at least one temperature sensor to an animal, to be placed in an animal's auditory canal,
characterized in that it comprises:
a first portion defining at least one housing capable of receiving at least one temperature sensor and means for transmitting at least one temperature value, and,
a second portion forming a spring,
said first portion and/or said second portion being configured to take support on at least two distinct zones of said auditory canal
said second portion comprising at least one spring leaf and said first portion being a helicoidal element connected to said at least one spring leaf.

2. Device according to claim 1, characterized in that said second portion is configured to take at least two positions, a compressed position in which said second portion is deformed so as to enable the insertion of said device into said auditory canal, and a holding position in which said second portion substantially resumes its original shape so as to hold said device fixedly attached to said auditory canal.

3. The device claim 1, characterized in that said housing comprises an entry hole for said temperature sensor and at least one air vent hole.

4. The device of claim 1, characterized in that said first portion is configured to take support on a first zone of said auditory canal and in that said second portion is configured to take support on a second zone of said auditory canal.

5. The device of claim 4, characterized in that said first portion defines a cylindrical housing, a height of which is configured to coincide with said first support zone of said auditory canal when said device is placed in said auditory canal.

6. The device of claim 1, characterized in that it also comprises a housing capable of receiving electronic means for identifying said animal.

7. The device of claim 1, characterized in that it comprises a marking surface for an identifier of said animal.

8. The device of claim 1, characterized in that it comprises means for removing said device.

9. System for affixing at least one temperature sensor to an animal, to be placed in an animal's auditory canal,
characterized in that it comprises:
a device for affixing according to any one of the claims 1 to 8;
at least one temperature sensor and means for transmitting at least one temperature value, inserted into a housing of the affixing device.

10. The system of claim 9, characterized in that it also comprises electronic means for identifying said animal, inserted into said housing or into another housing of said affixing device.
